(19) United States
(12) Patent Application Publication
(10) Pub. No.: US 2010/0207724 A1
(43) Pub. Date: Aug. 19, 2010

(54) Garage appliance control system, and building

(75) Inventor: Tatsuya Morii, Nagoya-Shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KASISHA, Toyota-Shi (JP)

(21) Appl. No.: 12/654,642

(22) Filed: Dec. 28, 2009

(30) Foreign Application Priority Data
Feb. 19, 2009 (JP) 2009-036468

(51) Int. Cl. G06F 7/04

(52) U.S. Cl. 340/5.71

(57) ABSTRACT

A garage appliance control system includes: at least one appliance installed in a garage that is provided as a portion of a building or a garage that is provided adjacent to the building; a first light emission portion which is provided in a vehicle that is parked in the garage, and which emits visible light; a first light reception portion that is provided in the garage, and that receives visible light emitted from the first light emission portion; and a control portion that controls the appliance based on light reception by the first light reception portion.

### INCORPORATION BY REFERENCE

The disclosure of Japanese Patent Application No. 2009-036468 filed on Feb. 19, 2009 including the specification, drawings and abstract is incorporated herein by reference in its entirety.

### BACKGROUND OF THE INVENTION

1. Field of the Invention

The invention relates to a control system for appliances that are installed in a garage in which a vehicle is parked, and to a building equipped with an attached garage in which a garage-side element of the control system is provided.

2. Description of the Related Art

A technology that controls actions of various appliances through a remote manipulation using wireless communication (remote manipulation using a remote controller) is widely known, as represented by home electrical appliances such as television sets, and the like. Then, as the remote-control manipulation becomes possible, improvements in the ease of use of appliances, the convenience thereof, etc., come about.

This applies similarly to appliances that are installed in a garage that has a parking space for a vehicle, specifically, an attached garage provided as a part of a building, or a garage adjacent to a building. For example, in Japanese Patent Application Publication No. 2003-143662 (JP-A-2003-143662), a technology that remote-controls the opening and closing actions of a shutter device that is provided at an entrance/exist opening of the garage, and the like, via a remote controller, is known.

By the way, in the remote-control manipulation using wireless communication, it is impossible to check whether or not the wireless communication is actually occurring between the remote controller and an appliance that is an object of the remote control, by actually seeing the communication itself. Therefore, particularly in the case where an action that cannot be visually checked (e.g., the locking of a door, or the like) is to be controlled, it cannot be grasped whether or not the manipulation commanded by the remote controller has actually been carried out, unless a person checks the state of action in reality.

However, if every manipulation, after being remote-controlled, needs to be checked or confirmed by a person, the improved ease of use and convenience of the appliance provided by the remote control becomes meaningless. On the other hand, since the entrance/exist opening of the garage communicates with the outdoors, security of the building needs to be secured. Therefore, with regard to the appliances related to security, such as a shutter device or the like, the checking of the state of action thereof cannot be neglected.

### SUMMARY OF THE INVENTION

Accordingly, the invention provides a garage appliance control system that both secures the ease of use and the convenience, and achieves crime prevention, and to a building equipped with the garage appliance control system.

A garage appliance control system in accordance with a first aspect of the invention includes: at least one appliance installed in a garage that is provided as a portion of a building or a garage that is provided adjacent to the building; a first light emission portion which is provided in a vehicle that is parked in the garage, and which emits visible light; a first light reception portion that is provided in the garage, and that receives visible light emitted from the first light emission portion; and a control portion that controls the appliance based on light reception by the first light reception portion.

According to this construction, when the visible light emitted from the light emission portion (first light emission portion) of the vehicle side is received by the light reception portion (first light reception portion) of the garage side, appliances installed in the garage are remote-controlled. Since this remote control is performed by the communication using visible light, the state of communication between the vehicle side and the garage side can be checked by actually seeing it. Therefore, even in the case where the action of an appliance that is remote-controlled cannot be visually recognized, the need for a person to actually check the state of action is small, and the convenience of remote control is not impaired. This applies if the control object is an appliance related to crime prevention or security, such as a locking/unlocking device or the like. Hence, in the case where a security appliance is remotely manipulated, security can be secured without checking every state of action. That is, securement of ease of use and convenience, and security can both be achieved.

Incidentally, the foregoing appliance includes an appliance that is installed directly in the garage, but also an appliance that is installed indirectly in the garage. The appliance installed directly in the garage refers to an appliance that is installed by utilizing a floor portion, a ceiling portion, a wall portion, etc., that forms the garage. Examples of the appliance include a shutter device that is installed at an entrance/exist opening, an illumination device that is installed in the ceiling portion, etc. Besides, the appliance that is installed indirectly in the garage refers to an appliance that has a member or the like that is provided directly in the garage. Examples of the appliance installed indirectly in the garage include a door body provided in a wall portion, a locking/unlocking device provided on a window sash, etc.

Incidentally, the communication using visible light particularly facilitates the visual recognition. Since the demand for security heightens at night, the effect of the first aspect becomes remarkable at night. Besides, an appliance that is remote-controlled through the communication using visible light achieves a remarkable effect, in the case where the appliance is a security appliance that does not allow its security action to be visually checked at all or with ease, concretely, an electrical lock of a door body, or the like.

A building in accordance with a second aspect of the invention is a building equipped with the garage appliance control system in accordance with the first aspect, in which the garage is an attached garage that is provided as a portion of the building.

According to this construction, in the building having an attached garage that is provided as a portion of the building, appliances installed in the attached garage can be controlled.

### BRIEF DESCRIPTION OF THE DRAWINGS

The foregoing and/or further objects, features and advantages of the invention will become more apparent from the following description of example embodiments with reference to the accompanying drawings, in which like numerals are used to represent like elements and wherein:

FIG. 1 is a longitudinal sectional view of a building, showing an attached garage in accordance with an embodiment of the invention;

FIG. 2 is a block diagram showing a system construction of an appliance control system in accordance with the embodiment of the invention;

FIG. 3 is a table of correspondence between light emission patterns, and control contents, and the like in accordance with the embodiment of the invention;

FIG. 4 is a flowchart showing a light emission control process at the vehicle side in accordance with the embodiment of the invention;

FIG. 5 is a flowchart showing a garage appliance control process performed when a vehicle exits from the garage in accordance with the embodiment of the invention; and

FIG. 6 is a flowchart showing a garage appliance control process performed when a vehicle enters the garage in accordance with the embodiment of the invention.

### DETAILED DESCRIPTION OF EMBODIMENTS

Hereinafter, an embodiment of the invention will be described with reference to the drawings. In this embodiment, a stand-alone house is taken as a concrete example of the building, and an attached garage (also termed an inner garage) provided as a part of the house is taken as a concrete example of the garage. Besides, the control system of the invention is embodied as an appliance control system that controls not only appliances of the attached garage but also appliances of a vehicle that is parked in the attached garage.

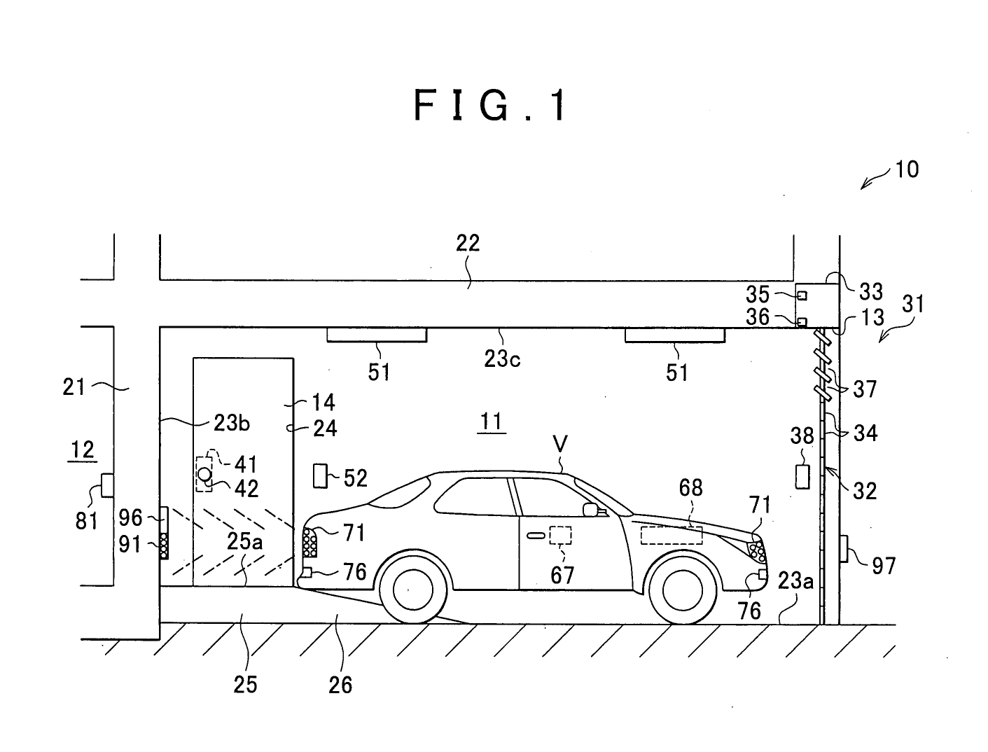

Firstly, an attached garage will be briefly described with reference to FIG. 1 prior to description of a system construction of an appliance control system in accordance with an embodiment of the invention. In addition, FIG. 1 is a longitudinal sectional view of a building, showing an attached garage.

As shown in FIG. 1, a stand-alone house 10 is provided with an attached garage 11 in a first-story portion. The attached garage 11 is partitioned by a wall portion 21 from a living space portion (a living or private room, or the like) 12 in the first-story portion, and is partitioned from a second-story portion by a first/second-story boundary portion 22. In addition, the wall portion 21 and the first/second-story boundary portion 22 each have a composite construction made up of various members, including a base material, a finish material, etc.

The attached garage 11 has an entrance/exist opening 13 for communication with the outdoors. Through the entrance/exist opening 13, a vehicle V or a resident moves in and out between the attached garage 11 and the outdoors. A parking space for the vehicle V and a passageway space are provided inward of the entrance/exist opening 13. A space inside the garage combining the foregoing two spaces is defined by interior surfaces of the attached garage 11, that is, a floor surface 23a, interior wall surfaces 23b, and a ceiling surface 23c. As for the parking space, for example, a space that allows one vehicle V to be parked is secured. On the other hand, the passageway space is provided beside the parking space, and is a space along the right-side wall portion 21 in a view from the entrance/exist opening side. The passageway space is provided with a raised floor portion 25, and a slope 26.

A floor surface 25a of the raised floor portion 25 is higher than the floor surface 23a of the attached garage 11, and is at the same height as the floor surface of the living space portion 12 in a first-story portion of the building. The raised floor portion 25 is provided, projected from the wall portion 21 into the space of the garage. An area of the wall portion 21 that is provided with the raised floor portion 25 is provided with an opening portion 24 that communicates with the living space portion 12. The slope 26 connects the floor surface 23a of the attached garage 11 and the floor surface 25a of the raised floor portion 25, and thus makes it easy for residents to move between the floor surface 23a and the floor surface 25a. Then, residents move in and out between the attached garage 11 and the living space portion 12 via the opening portion 24, the raised floor portion 25, and the slope 26. When a resident moves in or out through the opening portion 24, a door body 14 disposed in the opening portion 24 is opened and closed.

It is to be noted herein that the attached garage 11 having the foregoing construction is equipped directly or indirectly with various appliances. Next, such various appliances will be described. It is assumed that three kinds of appliances described below are installed as concrete examples.

Firstly, a shutter device 31 for security of the stand-alone house 10 and the attached garage 11 is provided at the entrance/exist opening 13 of the attached garage 11. The shutter device 31 is installed by utilizing the interior wall surfaces 23b and the ceiling surface 23c of the attached garage 11, and the like, and thus is an appliance that is directly installed in the attached garage 11. The shutter device 31 that opens and closes the entrance/exist opening 13 includes a shutter curtain 32, and a shutter case 33.

The shutter curtain 32 is a slat-type shutter curtain that has such a planar area as to be able to close the entire area of the entrance/exist opening 13, and that is made up of many slats 34 linked to one another. The slats 34 formed in an elongated platy shape are juxtaposed vertically with their lengths being in the horizontal direction (vehicle width direction), and vertical adjacent slats are interlinked. The linking construction of the slats 34 is well known, and detailed description thereof is omitted herein.

A shutter case 33 that houses the shutter curtain 32 is a laterally elongated-shaped box body, and is disposed above the entrance/exist opening 13. The shutter case 33 houses the shutter curtain 32 in a rolled-up state, and is provided with a rolling drive portion 35, such as an electric motor or the like, which serves as a rolling-up or rolling-out drive source for the curtain 32. When the shutter curtain 32 is rolled out from a rolled-housed state, the shutter curtain 32 is let out downward from the shutter case 33, and thus descends. When the shutter curtain 32 descends until a lower end portion thereof contacts the floor surface 23a (a state shown in FIG. 1), the entire area of the entrance/exist opening 13 is closed by the shutter curtain 32. On the other hand, when the shutter curtain 32 is rolled up from the lowered state, the shutter curtain 32 ascends, and is housed in the shutter case 33 in a rolled state. When the shutter curtain 32 is entirely housed in the shutter case 33, the entire area of the entrance/exist opening 13 is open.

When the entire area of the entrance/exist opening 13 is closed, the locking by a shutter electrical lock is automatically performed, so that the ascent and descent of the shutter curtain 32 is restricted. This prevents failure to lock the shutter, and thus enhances security characteristic. The shutter electrical lock used herein is a well-known lock, and description thereof is omitted.

The shutter device 31 opens and closes the entire area of the entrance/exist opening 13 of the attached garage 11, by raising and lowering the shutter curtain 32. In addition, the shutter device 31 also has a function of opening and closing all or some of the slats 34. That is, each of the slats 34 is connected so as to be pivotable about an axis that extends in the horizontal direction (vehicle width direction), so that the slats 34 can be changed between an open state and a closed state as they are pivoted by a drive source, that is, a slat driving portion 36, such as an electric motor or the like. The slat opening-closing mechanism is also well-known, and detailed description thereof is omitted. FIG. 1 shows a situation in which a plurality of slats are in the open state. As shown in FIG. 1, short sides of slats are upstanding in the vertical direction in the closed state, and are inclined in the open state. Then, in the open state of slats, laterally elongated vent portions 37 are formed between vertically adjacent slats. Thus, even when the shutter device 31 is in the closed state, natural ventilation of the attached garage 11 can be performed through the vent portions 37.

An manipulation portion 38 of the shutter device 31 that is provided in the wall portion 21 is equipped with a group of various switches for manipulating the ascent/descent of the shutter curtain 32, and the opening/closing of the slats. When a resident manipulates any one of the switches of the group, the requested action content is executed.

Secondly, a door electrical lock 41 is provided in the door body 14 of the attached garage 11. This door electrical lock 41 is provided in the door body 14 that is provided in the attached garage 11 of the wall portion 21, and thus is an appliance that is installed indirectly in the attached garage 11. The door electrical lock 41 is a well-known lock that electrically engages and disengages (locks and unlocks) a lock device, and, for example, is provided integrally with a knob portion 42. As for the locking and unlocking manner, the locking and unlocking is performed by a latch member of the lock device moving into and withdrawing from a latch hole that is provided in a frame portion of the door body 14. When the door body 14 is locked by the door electrical lock 41, it is impossible to open the door body 14 from the state of closing the opening portion 24, so that no one can move between the attached garage 11 and the living space portion 12 through the opening portion 24. Thus, security characteristic of the stand-alone house 10 is enhanced. On the other hand, when the door electrical lock 41 is disengaged, the door body 14 can be opened to open the opening portion 24, so that a resident can move through the opening portion 24.

Thirdly, an illumination device 51 is provided in the ceiling surface 23c of the attached garage 11. The illumination device 51 is installed by utilizing the ceiling surface 23c of the attached garage 11, and is an appliance that is installed directly in the attached garage 11. The illumination device 51 is a well-known device equipped with a luminaire that has a fluorescent lamp, or an incandescent light bulb, or the like. One or more illumination devices 51 (two illumination devices 51 in FIG. 1) are installed in the garage. By turning on the illumination device 51, the inside of the garage is illuminated. The illumination devices 51 are provided with manipulation switches 52 for manually manipulating the turning-on/off, or the like. The manipulation switches 52 are installed, for example, on an interior wall surface 23b.

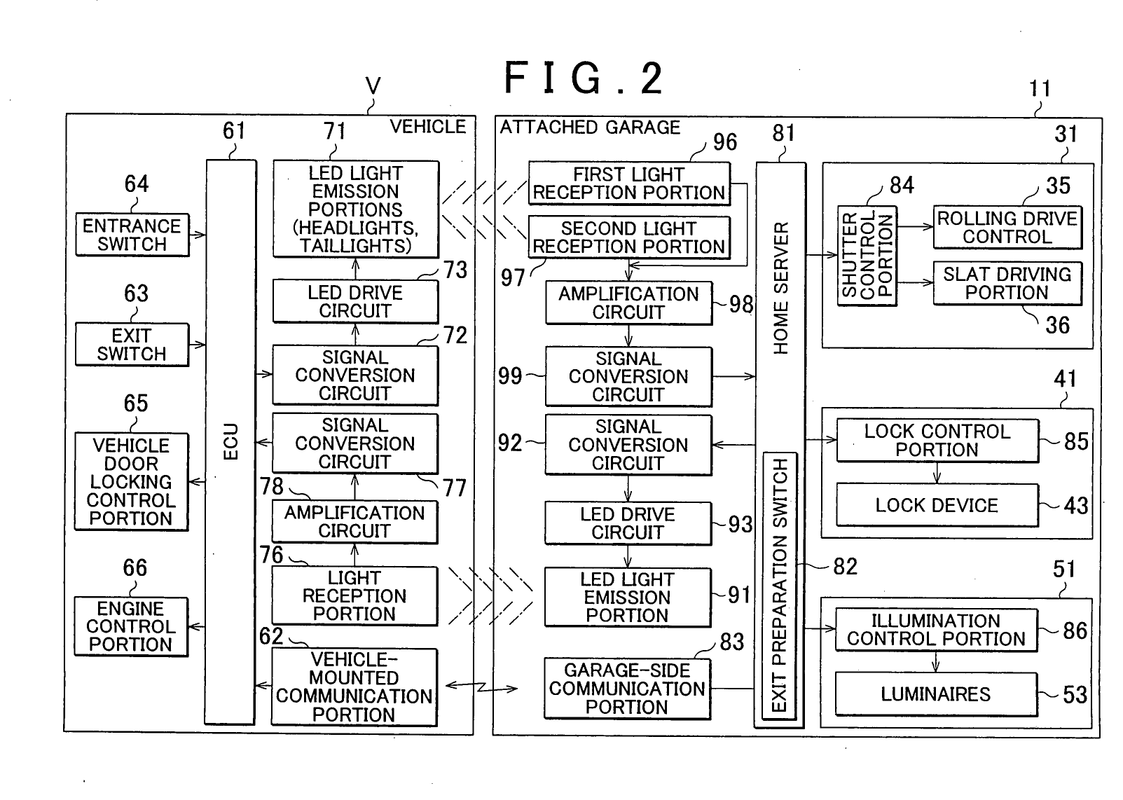

Next, a system construction of an appliance control system in accordance with the embodiment of the invention will be described. The attached garage 11 is equipped with an appliance control system that controls appliances that are mounted in a vehicle V that is parked in the attached garage 11, and the foregoing appliances that are installed directly or indirectly in the attached garage 11 (the shutter device 31, the door electrical lock 41, and the illumination device 51). The system construction thereof will be described with reference to the block diagram shown in FIG. 2.

Firstly, a construction at the vehicle side will be described. As shown in FIG. 2, this appliance control system includes as a component element an ECU 61 that is provided in the vehicle V parked in the attached garage 11.

The ECU 61 has a microcomputer that is made up of a CPU, various memories, etc., and centrally controls an engine provided in the vehicle V, vehicle-mounted accessories such as an air-conditioner, other vehicle-mounted appliances, etc.

The vehicle-mounted communication portion 62, the exit switch 63, and the entrance switch 64 are connected to the ECU 61. The vehicle-mounted communication portion 62 is, for example, a vehicle-mounted device for an electronic toll collection system, or a car navigation device or the like, and wirelessly transmits vehicle information regarding the vehicle V to the outside of the vehicle, via the vehicle-mounted communication portion 62. Incidentally, the vehicle-mounted communication portion 62 may be installed in the vehicle V, independently of the ECU 61, without being connected to the ECU 61. On the other hand, the exit switch 63, and the entrance switch 64 (corresponding to manipulation portions) are provided, for example, in a dashboard of the vehicle V. When the switch 63 or 64 is manipulated, a control content corresponding to the switch is executed. Incidentally, concrete control contents will be described later.

Besides, a vehicle door locking control portion 65 and an engine control portion 66 are connected to the ECU 61. The vehicle door locking control portion 65 controls a locking device 67 (see FIG. 1) of a door of the vehicle V. When the vehicle door locking control portion 65 receives a control signal from the ECU 61, the vehicle door locking control portion 65 controls the locking device 67 so that the vehicle door is locked or unlocked. Besides, the engine control portion 66 executes various controls of an engine 68 (see FIG. 1) that the vehicle V has, including the starting and the stopping thereof. Receiving a control signal from the ECU 61, the engine control portion 66 performs a corresponding engine control.

Besides, LED light emission portions 71 (corresponding to a light emission portion) and light reception portions 76 of the vehicle V are connected to the ECU 61. Firstly, the LED light emission portions 71 are headlights and taillights of the vehicle V (see FIG. 1). Theses lights each include an LED. Therefore, due to the LED light emission portion 71, light in the visible radiation range is emitted forward from the vehicle V (headlights), and light in the visible radiation range is emitted rearward from the vehicle V (taillights). A signal conversion circuit 72 (e.g., a modulation circuit), and an LED drive circuit 73 are interposed between the ECU 61 and the LED light emission portions 71. Therefore, output signals of the ECU 61 are converted into driving signals, and the LED drive circuit 73, receiving the driving signals, executes light emission.

The light reception portions 76 each include, for example, a photodiode that responds to light in the visible radiation range. Concretely, light reception portions 76 are provided at a rear end portion and a front end portion of the vehicle V (e.g., the front and rear bumpers) (see FIG. 1). Each of the light reception portions 76, receiving light in visible radiation range, outputs information regarding the light reception to the ECU 61. An amplification circuit 78 and a signal conversion circuit 77 (e.g., a demodulation circuit) are interposed between the ECU 61 and the light reception portions 76. Therefore, the light received by the light reception portions 76 is amplified, and is converted into an input signal for the ECU 61, before being input into the ECU 61.

Next, a construction at the attached garage side will be described. As shown in FIG. 2, the appliance control system includes a home server 81 as a component element.

The home server 81 (corresponding to a control portion) centrally controls various appliances, such as home electrical appliances, air-conditioning appliances, etc., which are installed in the stand-alone house 10. The home server 81 is installed at an arbitrary location (e.g., a living room or the like) in the living space portion 12. The home server 81 includes a personal computer that has a microcomputer that is made up of a CPU, various memories, etc., input means, such as a keyboard, switches, etc., display means, such as a display monitor, etc. As an example of the input means, an exit preparation switch 82 is provided. Then, in response to manipulation of the input means by a resident or the like, the home server 81 executes various controls or the like commensurate with the content of the manipulation, with respect to appliances that are control objects. In addition, a content of control performed in the case where the exit preparation switch 82 is manipulated will be described later.

A garage-side communication portion 83 capable of wireless communication with a vehicle-mounted communication portion 62 of the vehicle V parked in the attached garage 11 is connected to the home server 81. Therefore, the home server 81 is able to acquire vehicle information regarding the vehicle V via the two communication portions 62 and 83. Besides, a shutter control portion 84, a lock control portion 85, and an illumination control portion 86 are connected to the home server 81. Therefore, by the control signal output from the home server 81, the shutter control portion 84, the lock control portion 85 and the illumination control portion 86 are controlled.

The shutter control portion 84 controls the action of the shutter device 31, and is installed in the shutter case 33. The rolling drive portion 35, and a slat drive portion 36 are connected to the shutter control portion 84. The shutter control portion 84, receiving a control signal from the home server 81, controls the rolling drive portion 35 and the slat drive portion 36 to raise or lower the shutter curtain 32, or open or close the slats 34. Besides, the lock control portion 85 controls the action of the door electrical lock 41, and is contained in the door electrical lock 41, together with a lock device 43 that locks and unlocks the door body 14. The lock device 43 is connected to the lock control portion 85. When the lock control portion 85 receives a control signal from the home server 81, the lock control portion 85 then controls the lock device 43 to cause the door electrical lock 41 to lock or unlock the door body 14. Furthermore, the illumination control portion 86 controls the actions of the illumination device 51, and is contained in the illumination device 51, together with a luminaire 53. The luminaire 53 is connected to the illumination control portion 86. The illumination control portion 86, receiving a control signal from the home server 81, controls the luminaire 53 to turn it on or off.

In addition, an LED light emission portion 91, and a first light reception portion 96 and a second light reception portion 97 as two kinds of light reception portions, which are provided in the attached garage 11, are connected to the home server 81. The LED light emission portion 91 has an LED (light-emitting diode) as a light source, and is installed in one of the interior wall surfaces 23b of the attached garage 11 that is opposite the entrance/exist opening 13 (see FIG. 1). The LED light emission portion 91 is installed at a position that faces a light reception portion 76 of the vehicle V parked in the attached garage 11 (i.e., one of the light reception portion provided at the front end portion of the vehicle V and the light reception portion 76 provided at the rear end portion thereof, depending on the direction of parking). Therefore, when light in the visible radiation range is emitted from the LED light emission portion 91 to the parked vehicle V, the adjacent one of the light reception portions 76 of the vehicle V receives the light, and outputs light reception information to the ECU 61. Incidentally, the LED light emission portion 91 is the same as the foregoing vehicle-side LED light emission portions 71 in that the LED light emission portion 91 is provided with the signal conversion circuit 92 and the LED drive circuit 93 for the light emission.

The first light reception portion 96 and the second light reception portion 97 each include, for example, a photodiode that responds to light in the visible radiation range. Of these light reception portions, the first light reception portion 96 is installed in one of the interior wall surfaces 23 of the attached garage 11, as is the case with the LED light emission portion 91 (see FIG. 1), and is disposed at a position that faces an LED light emission portion 71 of the vehicle V parked in the attached garage 11 (a headlight or a taillight, depending on the direction of parking). Incidentally, the second light reception portion 97 is the same as the foregoing vehicle-side light reception portions 76 in that the second light reception portion 97 is provided with the amplification circuit 98 and the signal conversion circuit 99 for reception of light. Therefore, when light in the visible radiation range is emitted from the LED light emission portions 71 of the parked vehicle V, the first light reception portion 96 in the garage receives the light, and outputs light reception information to the home server 81. On the other hand, the second light reception portion 97 is installed at a position near the entrance/exist opening 13 of the attached garage 11 which is in an external wall portion where the entrance/exist opening 13 is formed. The second light reception portion 97 is disposed at substantially the same height as the LED light emission portions 71 of the vehicle V. Therefore, when the LED light emission portions 71 of the vehicle V present outdoors prior to entering the attached garage 10 emit light in the visible radiation range, the second light reception portion 97 receives the light, and outputs light reception information to the home server 81.

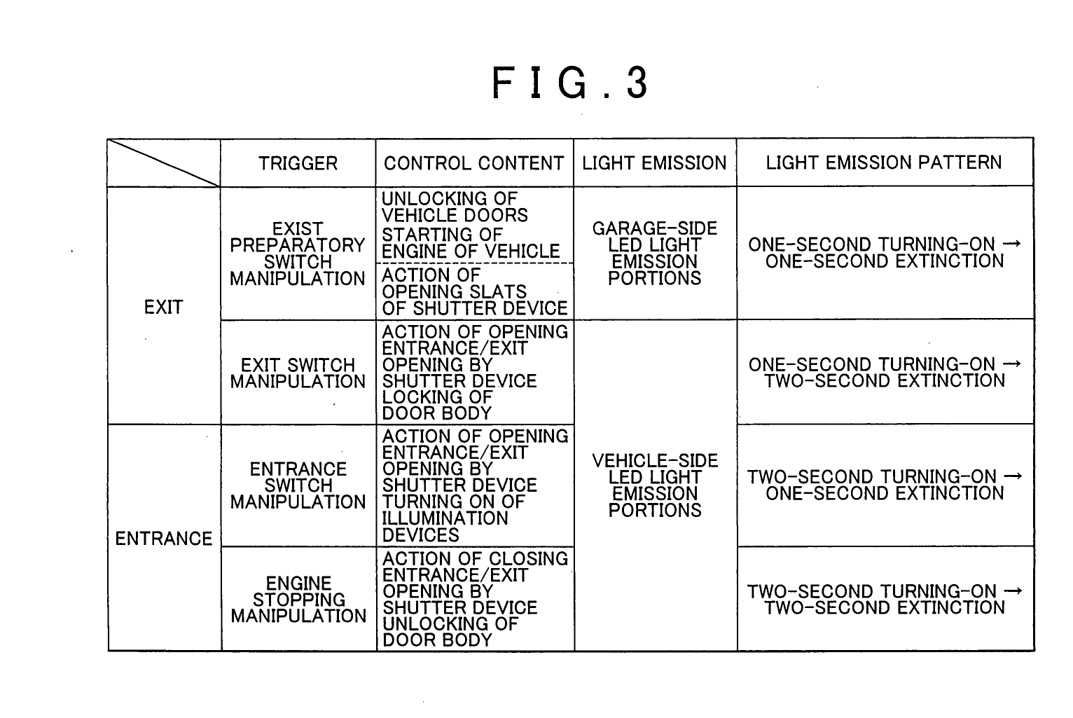

The appliance control system having the foregoing construction controls appliances of one of the vehicle side and the garage side on the basis of the light reception portion 76, 96, 97 of that side receiving the light emitted from the LED light emission portion 71, 91 of the other one of the vehicle side and the garage side. In this case, various appliances are provided on each of the vehicle side and the garage side, the contents of control required are different between the case where the vehicle V exits from the attached garage 11 and the case where the vehicle V enters the attached garage 11. Therefore, separately for the individual manipulations that serve as a trigger for execution of control and the individual concrete contents of control, light emission patterns of light emitted from the LED light emission portions 71, 91 are set beforehand, and the contents of setting are pre-stored in memories that are provided in the ECU 61 and the home server 81. The manipulations that serve as a trigger for execution of control, and the concrete contents of control performed in those cases as well as the light emission patterns associated in correspondence therewith, and the like will be described with reference to the correspondence table shown in FIG. 3.

As shown in FIG. 3, when the vehicle V parked in the attached garage 11 is to exit, the exit preparation switch 82 of the home server 81 is firstly manipulated by a resident or the like, so that the ECU 61 of the vehicle V performs a control of unlocking a vehicle door, and starting the engine. This control is performed when the LED light emission portion 91 of the garage side repeatedly emits light in a pattern of “one-second emission and one-second extinction” on the basis of the switch manipulation, and such light in that pattern is received by the light reception portions 76 of the vehicle V. Besides, due to the control by the home server 81 of the attached garage 11, the slats 34 of the shutter device 31 are opened.

After that, when a driver or the like who has gotten into the vehicle V, or the like, manipulates the exit switch 63 on the dashboard, the home server 81 of the attached garage 11 performs a control of opening the entrance/exist opening 13 (raising the shutter curtain 32), and locking the door body 14 of the attached garage 111. This control is performed when the LED light emission portions 71 of the vehicle side repeatedly emit light in a pattern of “one-second emission and two-second extinction” on the basis of the switch manipulation of the exit switch 63 by the driver or the like, and such light is received by the first light reception portion 96 of the garage side.

Besides, in the case where the vehicle V present outdoors is to enter the attached garage 11, the driver or the like firstly manipulates the entrance switch 64 on the dashboard, so that the home server 81 of the attached garage 11 performs a control of opening the entrance/exist opening 13 and turning on the illumination device 51. This control is performed when the LED light emission portions 71 of the vehicle side repeatedly emit light in a pattern of “two-second emission and one-second extinction” on the basis of the switch manipulation of the entrance switch 64 by a driver or the like, and such light is received by the second light reception portion 97 of the garage side.

Then, after the entrance of the vehicle V is completed and the driver or the like turns off the engine, the home server 81 of the attached garage 11 performs a control of unlocking the door body 14 and closing the entrance/exist opening 13 (lowering the shutter curtain 32). This control is performed when the LED light emission portions 71 of the vehicle side repeatedly emit light in a pattern of “two-second emission and two-second extinction” on the basis of an engine stopping manipulation, such as an engine operation key manipulation, or the like, and such light is received by the first light reception portion 96 of the garage side. Incidentally, since the engine stopping manipulation is also a manipulation that selects one of the light emission patterns, a site related to performance of the engine stopping manipulation (e.g., a key cylinder or the like) also corresponds to a manipulation portion in the invention.

Next, various control processes that the foregoing appliance control system executes will be described with reference to flowcharts as appropriate.

Firstly, an appliance control process of the vehicle V that the ECU 61 executes when light emitted from the garage side is received at the vehicle side at the time of exit of the vehicle V will be briefly described. In this case, a resident or the like who intends to move the vehicle V out of the garage manipulates the exit preparation switch 82 of the home server 81. In response to the manipulation, the home server 81 determines a light emission pattern that is associated in correspondence with that manipulation, and causes the LED light emission portion 91 of the garage side to emit light according to the light emission pattern. This light emission in the determined pattern is continued for a predetermined time (e.g., about 10 to 20 seconds). The correspondence between the manipulation of the exit preparation switch 82 and the light emission pattern is described above with reference to the table shown in FIG. 3.

When any one of the light reception portions 76 of the vehicle V receives light in the foregoing light emission pattern, the ECU 61 controls the vehicle door locking control portion 65 and the engine control portion 66 to disengage the locking device 67 of the vehicle door, and to start the engine 68. As a result, the resident or the like can get into the vehicle V without performing a manipulation of unlocking the vehicle doors, and can pull off the vehicle V without performing the engine starting manipulation. Besides, if the engine 68 is an internal combustion engine, it is also possible for the system to cause a warm-up operation of the engine 68.

However, if such a warm-up operation is performed, exhaust gas will fill the attached garage 11. That is, this operation arouses concern that the air environment in the attached garage 11 will deteriorate, since the entrance/exist opening 13 of the attached garage 11 is closed by the shutter device 31. Therefore, in response to the manipulation of the exit preparation switch 82, the home server 81 controls the shutter control portion 84 of the shutter device 31 to open some or all of the slats 34. This allows natural ventilation to occur through the vent portion 37, and therefore will restrain the deterioration of the air environment in the garage caused by exhaust gas. The ventilation can be accelerated if a ventilation fan is installed in the attached garage 11, and is driven along with the ventilation through the vent portion 37.

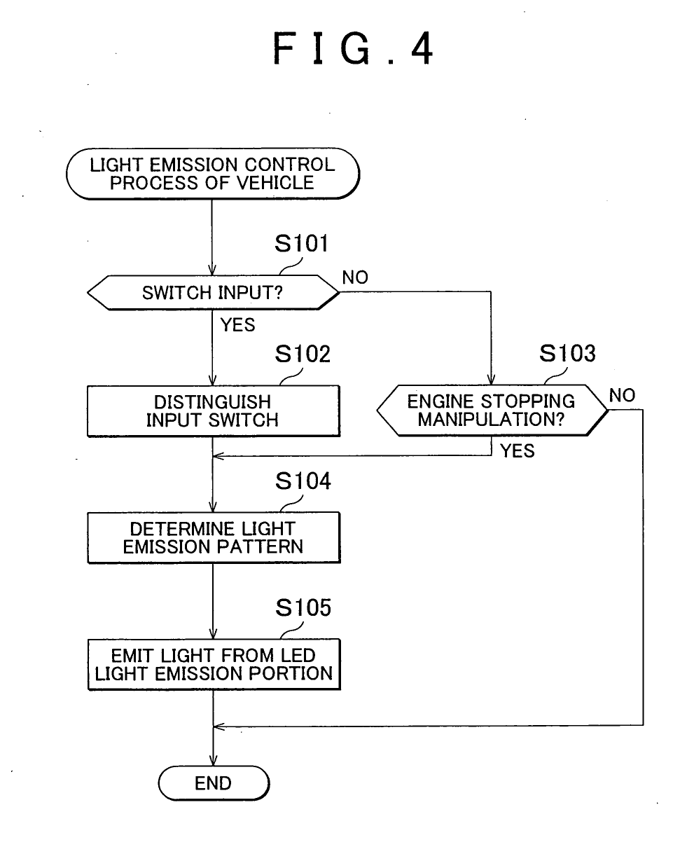

Next, a garage appliance control process that the home server 81 executes when light is emitted from the vehicle side, and is received at the garage side at the time of exist or entrance will be described with reference to the flowchart shown in FIG. 4 to FIG. 6.

As a premise, the light emission control process at the vehicle side will be described with reference to FIG. 4, which is a flowchart showing that process. Incidentally, this process is repeatedly executed by the ECU 61 at every predetermined cycle period.

As shown in FIG. 4, in step S101, the ECU 61 determines whether or not there has been a switch input. If there has been a switch input, that is, if the exit switch 63 or the entrance switch 64 has been manipulated, the ECU 61 makes an affirmative determination in step S101, and proceeds to step S102. In step S102, the ECU 61 distinguishes which one of the switches has made the input. After detecting the switch that has made the input in this distinction process, the ECU 61 proceeds to the next step.

On the other hand, if in step S101 there has been no switch input, the ECU 61 makes a negative determination, and proceeds to step S103. In step S103, the ECU 61 determines whether or not a manipulation of stopping the engine 68 has been performed in the vehicle V. If such an engine stopping manipulation has not been performed, the ECU 61 ends this process. If the foregoing engine stopping manipulation has been performed, the ECU 61 makes an affirmative determination in step S103, and proceeds to the next step.

In step S104, which is subsequent to the step S102 or step S103, the ECU 61 determines a light emission pattern in which the LED light emission portions 71 are caused to emit light. In this case, since it was determined in the preceding step (step S102 or step S103) which one of the input switches has been manipulated, or whether or not the engine stopping manipulation has been performed, a light emission pattern associated in correspondence with the manipulation determined in the preceding step is selected. The correspondence between the manipulation and the light emission pattern is as described above with reference to the table shown in FIG. 3.

Subsequently in step S105, the ECU 61 causes the LED light emission portions 71 to emit light according to the determined light emission pattern. As for the light emission from the LED light emission portions 71, both the headlights and the taillights may be turned on. Alternatively, it is also permissible to determine whether the front side or the rear side of the vehicle V is facing the light reception portion 96 or 97, from the direction in which the vehicle V is parked, and to cause the lights on the side facing the light reception portion 96 or 97 to emit light. In the case where it is determined whether the front side or the rear side of the vehicle is facing the light reception portion 96 or 97, from the direction in which the vehicle V is parked, and where light is emitted from the side facing the light reception portion 96 or 97, it is conceivable, as an example, to find the direction of the vehicle V from the position of the transmission shift lever at the time of entrance into the garage. The light emission from the LED light emission portions 71 in the selected pattern is continued for a predetermined time (e.g., about 10 to 20 seconds), and then this process ends.

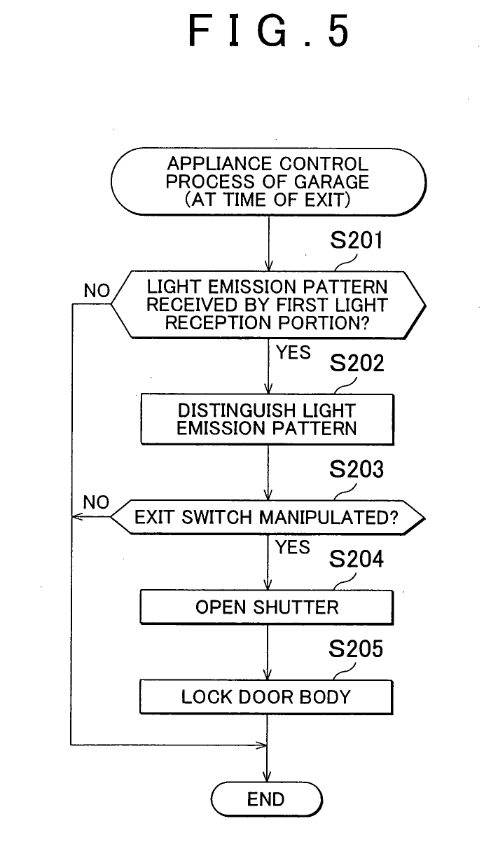

Next, a garage appliance control process executed when the vehicle V exits from the garage will be described with reference to FIG. 5, which is a flowchart showing that process. Incidentally, this process is repeatedly executed by the home server 81 at every predetermined cycle period.

As shown in FIG. 5, in step S201, the home server 81 determines whether or not the first light reception portion 96 in the garage has received light in a predetermined light emission pattern. If such light in the emission pattern has not been received, that is, if no light has been received, or if although light has been received, the light is continuously emitted light, single-flash light, etc., the home server 81 makes a negative determination in step S201, and immediately ends this process.

On the other hand, if light in a predetermined light emission pattern has been received, that is, if light in a predetermined light emission pattern emitted from the LED light emission portions 71 of the vehicle V parked in the attached garage 11 has been received, the home server 81 makes an affirmative determination in step S201, and proceeds to step S202. In step S202, the home server 81 distinguishes the light emission pattern of the light received. When a resident or the like manipulates the exit switch 63 of the vehicle V in order to move the vehicle V out of the garage, light is emitted from the LED light emission portions 71 of the vehicle side, in a light emission pattern that corresponds to the manipulation of the exit switch, according to the light emission control process performed at the vehicle side (see FIG. 4). Then, it is determined whether or not the light received by the first light reception portion 96 is in the foregoing light emission pattern distinguished in step S202.

If the light emission pattern of the light received is not related to the manipulation of the exit switch 63, the home server 81 makes a negative determination in step S203, and ends this process. On the other hand, if the light emission pattern of the light received by the first light reception portion 96 is the light emission pattern that is associated in correspondence with the manipulation of the exit switch 63, the home server 81 makes an affirmative determination in step S203, and proceeds to step S204 and S205, in which the appliances are controlled. Specifically, in step S204, the home server 81 outputs a control signal to the shutter control portion 84 of the shutter device 31, and thereby raises the shutter curtain 32 to entirely open the entrance/exist opening 13. In step S205, the home server 81 outputs a control signal to the lock control portion 85 of the door electrical lock 41, and thereby causes the lock device 43 to lock the door body 14.

After the foregoing control process is executed, a post-process subsequent to the completion of the exit of the vehicle V from the garage 11 is performed by the home server 81. As for this post-exit process, the reception by the first light reception portion 96 of the visible light that is emitted from the vehicle side in response to the manipulation of the exit switch 63 is used as a trigger for the post-process. In this embodiment, the home server 81 determines whether or not vehicle information regarding the vehicle V is being received from the vehicle-mounted communication portion 62 by the garage-side communication portion 83. Then, when the vehicle information becomes unable to be acquired as the vehicle has exited and has gone far, the home server 81 executes a predetermined control. Concretely, the home server 81 lowers the shutter curtain 32 of the shutter device 31 to entirely close the entrance/exist opening 13, and turns off the illumination device 51 if it is on. The post-exit process may instead be executed as follows. That is, when a switch manipulation in the vehicle V is performed, light is emitted from the vehicle side in a predetermined light emission pattern. The post-process is executed on the basis of the reception of the light in that pattern by the second light reception portion 97 disposed near the entrance/exist opening.

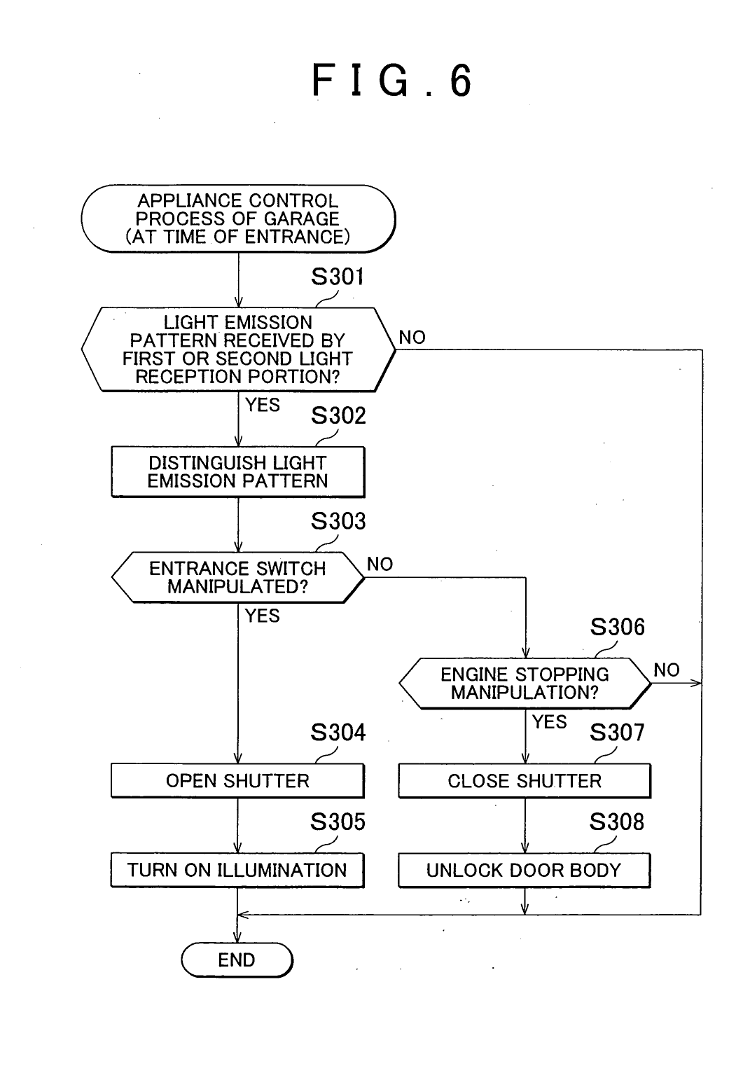

Next, a garage appliance control process performed at the time of entrance of the vehicle V will be described with reference to FIG. 6, which is a flowchart showing that process. This process is also repeatedly executed by the home server 81 at every predetermined cycle period. It is presumed that there are a preparatory stage and a post-stage in conjunction with the entrance of the vehicle V into the attached garage 11. As for the preparatory stage, preparation prior to the entrance is performed while the vehicle V is present on the outdoor side of the entrance/exist opening 13. The post-stage process is performed after the entrance preparation has been completed and the vehicle V has entered the garage.

As shown in FIG. 6, in step S301, the home server 81 determines whether or not the garage-side first light reception portion 96 (within the garage) or the garage-side second light reception portion 97 (near the entrance/exist opening) has received light in a predetermined light emission pattern. If no such light in that pattern has been received, that is, if no light has been received, or if light has been received but the received light is continuously emitted light, single-flash light, etc., the home server 81 makes a negative determination in step S301, and immediately ends this process.

On the other hand, if light in the predetermined light emission pattern has been received, the home server 81 makes an affirmative determination in step S301, and proceeds to step S302. Specifically, in the case where light emitted in a predetermined light emission pattern from the LED light emission portions 71 of the vehicle V during the preparatory stage is received by the second light reception portion 97, or where light emitted in the predetermined light emission pattern from the LED light emission portions 71 of the vehicle V during the post-stage is received by the first light reception portion 96, the process proceeds to step S302. In step S302, the home server 81 distinguishes the light emission pattern of light received. During the preparatory stage, the driver or the like manipulates the entrance switch 64 of the vehicle V, or performs a manipulation for stopping the engine 68 during the post-stage. In these cases, according to the foregoing light emission control process at the vehicle side (see FIG. 4), light is emitted in light emission patterns that correspond to various manipulations, from the LED light emission portions 71. That is, it is distinguished whether or not the light emission pattern of the light received by the first light reception portion 96 or the second light reception portion 97 is any one of the foregoing light emission patterns.

In the case where the light emission pattern of the light received is the one that is associated in correspondence with the manipulation of the entrance switch 64, the home server 81 makes an affirmative determination in step S303, and proceeds to step S304 and step S305, in which control of appliances in the preparatory stage is executed. Specifically, in step S304, the home server 81 outputs control signal to the shutter control portion 84 of the shutter device 31, and thereby raises the shutter curtain 32 to entirely open the entrance/exist opening 13. In step S305, the home server 81 outputs a control signal to the illumination control portion 86 of the illumination device 51, and thereby turns on the illumination device 51. As a result, the preparation for the entrance of the vehicle V into the attached garage 11 is completed. After that, the home server 81 ends this process.

On the other hand, in the case where the light emission pattern of the light received is the one that is associated in correspondence with the manipulation of stopping the engine 68, the home server 81 makes a negative determination in step S303, but makes an affirmative determination in the subsequent step S306. Then, the home server 81 proceeds to step S307 and step S308, in which control of appliances in the post-process is executed. Specifically, in step S307, the home server 81 outputs a control signal to the shutter control portion 84 of the shutter device 31, and thereby lowers the shutter curtain 32 to entirely closes the entrance/exist opening 13. In step S308, the home server 81 outputs a control signal to the lock control portion 85 of the door electrical lock 41, and thereby controls the lock device 43 to unlock the door body 14. Due to this, security of the attached garage 11 can be secured, and the need for a resident or the like to unlock the door body 14 using a key or the like disappears. After that, the home server 81 ends this process.

Besides, if the light emission pattern of the light received is not related to either the manipulation of the entrance switch 64 or the manipulation of stopping the engine 68, the home server 81 makes a negative determination in step S303 and in step S306, and then ends this process.

The appliance control system that controls the appliances of the vehicle V and the appliances of the attached garage 11 through the communication using visible light has been described above. According to the foregoing appliance control system, the following advantageous effects are obtained.

Firstly, as the visible light emitted from the LED light emission portions 71 of the vehicle V is received by the light reception portion 96 or 97 of the garage side, the appliances that are installed directly or indirectly on the attached garage 11 (the shutter device 31, the door electrical lock 41, and the illumination device 51) are remote-controlled. Since this remote control is performed through the communication using visible light, a resident or the like can visually check the state of the communication between the vehicle side and the garage side, and therefore can feel safe.

Since the communication state can be visually checked, the need for a person to actually check the state of action of an appliance is small even if the appliance does not allow the remote-controlled action thereof to be visually recognized, and is related to security (as in the case of the door electrical lock 41, which does not allow its locking/unlocking actions to be visually recognized). Therefore, security can be secured without a need to check every state of action. That is, both the ease of use and convenience of the remote control and the security can be achieved. Incidentally, the communication using visible light particularly facilitates the visual recognition. Since the demand for security heightens at night, the effect of achieving both the securement of convenience and the security becomes remarkable at night.

Secondly, a plurality of kinds of appliances are installed directly or indirectly in the attached garage 11, and the contents of control of the various appliances vary for various situations, for example, a situation of exit of the vehicle V from the garage, a situation of entrance of the vehicle V into the garage, etc. Therefore, a plurality of different light emission patterns are set for the light emission from the LED light emission portions 71. The light emission patterns are associated in correspondence with contents of control, and manipulations performed at the vehicle side. Therefore, if in response to a manipulation performed at the vehicle side, one light emission pattern is selected and light is accordingly emitted, the control that is associated in correspondence with the manipulation can be executed.

Thirdly, since blinking light is used for the communication using visible light, the communication light can easily be discriminated from the light emission of the LED light emission portions 71 (the taillights and the headlights) performed during normal use. Therefore, incidents where the communication using the visible light is mistaken for the light emission caused by the normal use. Besides, not only the light emission duration but also the extinction duration is changed to provide many light emission patterns, so that many situations that require different contents of control can be set.

Fourthly, since the headlights and/or the taillights that are essentially provided in the vehicle V are used as the LED light emission portions 71, there is no need to install in the vehicle V new light emission portions for optical communication. Therefore, the number of component parts that constitute the system can be lessened. Besides, since the LED light emission portions 71 employ LEDs (light-emitting diodes) that are excellent in directivity as light sources, the light reception portions 96 and 97 easily receive light emitted from the LED light emission portions 71.

Fifthly, the garage side is also provided with the LED light emission portion 91, and the vehicle side is provided with the light reception portions 76 that receive light from the LED light emission portion 91. Therefore, by the light emission from the garage side, appliances installed in the vehicle V (e.g., the locking device 67 of the vehicle doors, and the engine 68) can be controlled. Therefore, even when a vehicle-side appliance is remote-controlled, a resident or the like can visually check the state of communication, and can feel safe.

Besides the foregoing embodiment, the invention can also be carried out in, for example, the forms that are shown below as other examples.

Although in the foregoing embodiment, the garage-side appliances that are control objects are the shutter device 31, the door electrical lock 41, and the illumination device 51, the garage-side appliances that are control objects may also be security appliances, such as a warning device provided for the shutter device 31, a reporting device for reporting to a security company. Besides, the control objects may also include a locking/unlocking device installed on a window that is provided in an interior wall surface 23b of the attached garage 11, an appliance installed at a site apart from the garage (e.g., an electrical lock of the front door of a house), etc. Furthermore, an electrical charging appliance may also be a control object. This will be suitable for the case where a vehicle V which is equipped with an electric motor that is driven by electric power stored in a battery mounted in the vehicle as a drive source thereof, and which is capable of charging the battery with electricity supplied from an external device (e.g., a plug-in hybrid vehicle (PHV), an electric vehicle, etc.) is parked in the attached garage 11. On the other hand, the vehicle-side appliances that are control objects may include vehicle-mounted accessories, such as an air-conditioner and the like, as well as the locking device 67 of the vehicle doors, and the engine 68.

Brief supplementary description of the embodiment in which the electrical charger appliance is controlled will be given. In this case, according to the vehicle-side light emission control process, using as a trigger a manipulation of a charging switch provided in the vehicle V, or a manipulation of stopping the electric motor, etc., light is emitted by the LED light emission portions 71 of the vehicle V in a light emission pattern that is associated in correspondence with the manipulation. When the light in this pattern is received by the first light reception portion 96 of the garage side, the home server 81 (corresponding to a charging need determination portion in the invention) firstly determines whether or not electrical charging is needed on the basis of the amount of light received. That is, if the amount of electricity stored in the vehicle-mounted battery is short, the amount of light emitted from the LED light emission portions 71 is small, and therefore the amount of light received by the first light reception portion 96 is also small. Utilizing this phenomenon, it is determined that charging is needed if the amount of light reception becomes less than a predetermined value. Therefore, if the home server 81 determines that charging is needed as a result of the determination as to the presence/absence of need for charging, the home server 81 causes the electrical charging appliance to enter an activated state. Simultaneously with this operation, the home server 81 notifies a resident or the like that charging is needed, via a notification portion (voice, light, liquid crystal screen display, etc.) that is provided on the electrical charging appliance or the like.

Thus, in the case where it is determined that the electrical charging of the vehicle V is needed, that information is notified, and the electrical charging appliance enters the acting state, so that a resident or the like recognizes that charging is needed, and a charging operation is immediately performed. In consequence, unnecessary charging operation will be eliminated, and the convenience of the charging operation can be heightened. Besides, the presence/absence of need for charging is determined utilizing the optical communication that is performed in order to control the electrical charging appliance, light used for communication can effectively used for a purpose other than communication.

Besides, light may also be emitted separately from the light emission in the light emission pattern that is set for the charging control, and the amount of light received at that time is utilized for the determination as to whether or not charging is needed. Besides, the light emission utilized for the determination as to the presence/absence of the need for charging is preferably performed in a state where the charging or discharging of the vehicle-mounted battery is not occurring. Therefore, since the amount of electricity stored in the vehicle-mounted battery can be accurately detected, the presence/absence of need for charging can be accurately determined. Incidentally, the charging of the battery is caused by the power generation of an electric generator that is performed along with operation of a vehicle-driving electric motor, and the discharging of the battery is caused by the power consumption of the vehicle-driving electric motor, vehicle-mounted accessories, such as an air-conditioner, and the like. In that sense, it is appropriate that the light emission that is utilized for determination as to the presence/absence of need for charging be performed while operation of the vehicle V is stopped.

Furthermore, if the charging appliance is substantially thoroughly automated (e.g., the connection between the charging appliance and the vehicle V is automatically performed), a content of control of the charging appliance may be set such that the start and the end of the automatic charging action are controlled by light emitted from the vehicle V.

Besides, although in the foregoing embodiments, the vehicle information acquired from the vehicle V through the wireless communication between the vehicle-mounted communication portion 62 and the garage-side communication portion 83 is utilized for the post-exit process, that vehicle information may also be used for an authentication process for the vehicle V prior to the entrance into the garage. In this case, the authentication process is performed utilizing the acquired vehicle information. Only when the authentication of the vehicle information is obtained, the appliances of the garage side are controlled. The appliances that are controlled after the authentication of the vehicle information is obtained may be all the appliances, or may instead be only appliances that are related to security, such as the shutter device 31, the door electrical lock 41, etc. This prevents the security functions of the security appliances from being disabled by light emitted from an inauthentic vehicle, and therefore further heightens the security characteristic of the attached garage 11.

Besides, the foregoing embodiments, the second light reception portion 97 is installed near the entrance/exist opening of the attached garage 11, and optical communication is performed between the vehicle V and the attached garage 11 during the preparatory stage for entrance as well. However, the second light reception portion 97 or the entrance switch 64 may also be omitted. As a result, it becomes impossible to control appliances by utilizing optical communication during the preparatory stage for entrance. However, it suffices that the control during the preparatory stage be executed on condition that the vehicle information has been acquired from the vehicle-mounted communication portion 62 of the vehicle V, or on condition that identification information has been acquired from a portable device, etc. In this case, security can be secured by performing an authentication process for the acquired vehicle information or identification information.

Besides, the foregoing embodiments adopt a construction in which the LED light emission portion 91 is installed at the garage side, and the light reception portions 76 are installed at the vehicle side, and in which appliances of the vehicle side are controlled after the vehicle side receives light emitted from the garage side. However, it is also permissible to omit this construction while retaining merely a construction in which appliances of the garage side are controlled in response to light emitted from the vehicle side.

Besides, although the foregoing embodiments, all the light emission portions of the vehicle side and the garage side for use for optical communication are the LED light emission portions 71 and 91, the light emission portions may also employ light sources, such as halogen lamps, or the like, which are other than LEDs. However, in view of utilization in optical communication, it is preferable to use LEDs that are excellent in directivity.

Besides, although in the foregoing embodiments, the light emission patterns are discriminated from each other by their different durations of light emission or different intervals of blinking of the LED light emission portions 71 and 91, the light emission patterns may also be discriminated from each other by utilizing different wavelengths in the visible radiation range, the intensities of the light emission amount, etc. In addition to blinking, a continuous emission of light of a predetermined length of time may also be utilized as a light emission pattern. In the case where continuously emitted light is utilized, different light emission patterns can be created by varying the duration of continuous emission of light.

Furthermore, the communication using visible light may employ only continuously emitted light. In this case, there is no need to install a new light emission portion capable of blinking in the vehicle V, or to install a new component part or the like which enables the blinking light emission from the headlights or the taillights. Therefore, universality in the kinds of vehicles V to which the system is applicable can be secured.

Besides, in the foregoing embodiments, the control of the shutter device 31 performed during a post-entrance stage is merely lowering the shutter curtain 32 to close the entrance/exit opening 13. However, in addition to these controls, the slats 34 may also be opened for a predetermined time. This will contribute to improvement of the air environment in the attached garage 11, in the case where the engine 68 is an internal combustion engine.

The control of opening the slats 34 of the shutter device 31 when the vehicle V exits may also be performed along with a manipulation of starting the engine of the vehicle V, instead of being performed in response to the manipulation of the exit preparation switch 82. In this case, using the manipulation of starting the engine as a trigger, a light emission pattern in which the LED light emission portions 71 are caused to emit light is set. The light emission pattern is associated in correspondence with the slat opening action.

Besides, in the foregoing description of the embodiments, the home server 81 that centrally controls various appliances that are installed in the stand-alone house 10 is an example of control means, a controller dedicated to the appliance control system may also be provided, and may be used as the control portion.

Besides, in the foregoing embodiments, the stand-alone house 10 is a concrete example of the building, and the attached garage 11 provided as a part of the stand-alone house 10 is a concrete example of the garage. However, the building having the attached garage 11 may also be an apartment house, a shop building, etc. Besides, instead of the attached garage 11, the garage may also be a garage built adjacent to the building. Besides, in the embodiments, the attached garage 11 is provided with the opening portion 24 and the door body 14, which allow residents to move between the attached garage 11 and the living space portion 12. However, the garage may be an attached garage that is not provided with such an opening portion 24 or such a door body 14.

Besides, as a content of control of appliances of the vehicle side, a travel or run control of the vehicle V, for example, an assist in the entrance into the garage, may also be executed by utilizing the LED light emission portions 71 and 91, and light reception portions 76, 96 and 97 provided on the vehicle side and the garage side. For example, a control of grasping the position of the vehicle V and guiding the vehicle V to a predetermined parking position, or a control of stopping the vehicle V if the driver makes a mistake in operating the vehicle V at the time of entrance into the garage.

While the invention has been described with reference to example embodiments thereof, it should be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

What is claimed is:

1. A garage appliance control system comprising:
at least one appliance installed in a garage that is provided as a portion of a building or a garage that is provided adjacent to the building;
a first light emission portion which is provided in a vehicle that is parked in the garage, and which emits visible light;
a first light reception portion that is provided in the garage, and that receives visible light emitted from the first light emission portion; and
a control portion that controls the appliance based on light reception by the first light reception portion.

2. The garage appliance control system according to claim 1, further comprising a manipulation portion that is provided in the vehicle,
wherein:
a plurality of appliances are installed;
a plurality of different light emission patterns for light emission from the first light emission portion are set, and the light emission patterns are associated in correspondence with contents of control of the appliances;
the manipulation portion is manipulated so that light is emitted in a light emission pattern selected from the plurality of different light emission patterns; and
the control portion distinguishes which one of the light emission patterns has been received, and executes a content of control of the appliance that is associated in correspondence with the distinguished light emission pattern.

3. The garage appliance control system according to claim 2, wherein at least one of the light emission patterns is a pattern in which the visible light is blinked while being emitted.

4. The garage appliance control system according to claim 2, wherein the light emission pattern includes a plurality of blinking patterns using the visible light.

5. The garage appliance control system according to claim 1, wherein the visible light emitted from the first light emission portion is continuously emitted light whose emission is continued for a predetermined time.

6. The garage appliance control system according to claim 1, further comprising:
a vehicle-mounted communication portion provided in the vehicle; and
a garage-side communication portion that is provided in the garage, and that acquires vehicle identification information by performing wireless communication with a vehicle-mounted communication portion of the vehicle, wherein:
the appliance is a security appliance related to the garage; and
when the vehicle enters the garage, the control portion disables a security function of the security appliance on a condition that the vehicle identification information acquired via the garage-side communication portion is authenticated.

7. The garage appliance control system according to claim 1, further comprising:
a battery that is mounted in the vehicle, and that is capable of being charged with electricity supplied from an external device; and
an electric motor that is mounted in the vehicle, and that is driven by electric power stored in the battery provided as a drive source,
wherein
the appliance is an electrically charging appliance for the vehicle.

8. The garage appliance control system according to claim 7, further comprising a charging need determination portion that determines whether or not electrical charging of the vehicle is needed, based on amount of light reception obtained when visible light emitted from the first light emission portion is received by the first light reception portion.

9. The garage appliance control system according to claim 8, wherein the charging need determination portion determines whether or not electrical charging of the vehicle is needed, based on the amount of visible light which is emitted when the battery is neither being charged nor being discharged, and which is received by the first light reception portion.

10. The garage appliance control system according to claim 1, wherein:
the first light emission portion is at least one of a headlight and a taillight of the vehicle that faces the first light reception portion; and
a light source of each of the headlight and the taillight is an Light Emitting Diode.

11. The garage appliance control system according to claim 1, wherein the appliance is at least one of a shutter device for crime prevention, a door electrical lock of the building, and an illumination device that illuminates inside the garage.

12. The garage appliance control system according to claim 1, wherein:
the appliance includes a shutter device for crime prevention, and a door electrical lock of the building;
when the vehicle exits, the control portion performs a control of causing the shutter device to open an entrance/exist opening of the garage, and of engaging the door electrical lock; and
after the vehicle has entered, the control portion performs a control of causing the shutter device to close the entrance/exist opening of the garage, and of disengaging the door electrical lock.

13. The garage appliance control system according to claim 12, wherein:
the appliance further includes an illumination device that illuminates inside the garage; and
when the vehicle enters, the control portion performs a control of causing the shutter device to open the entrance/exist opening of the garage, and of causing the illumination device to illuminate inside the garage.

14. The garage appliance control system according to claim 1, further comprising:
a second light emission portion that is provided in the garage, and that emits visible light; and
a second light reception portion which is provided in the vehicle that is parked in the garage, and which receives visible light emitted from the second light emission portion,
wherein the control portion controls the appliance based on light reception by the first light reception portion, and controls the vehicle based on light reception by the second light reception portion.

15. The garage appliance control system according to claim 14, wherein:
control of the appliance based on light reception by the first light reception portion is a control of the shutter device for crime prevention;
control of the vehicle based on light reception by the second light reception portion is an engine starting control of the vehicle, and
the control portion performs a control of opening a portion of the shutter device along with starting of the engine of the vehicle.

16. A building equipped with the garage appliance control system according to claim 1, wherein
the garage is an attached garage that is provided as a portion of the building.
